(19) United States
(12) Patent Application Publication
(10) Pub. No.: US 2021/0285650 A1
(43) Pub. Date: Sep. 16, 2021

(54) DRUM HEATER ASSEMBLY

(71) Applicant: Illinois Tool Works Inc., Glenview, IL (US)

(72) Inventors: Sai Krishna Pranav Kompalli, Hermitage, TN (US); David Eugene Thompson, JR., Greenbrier, TN (US); Andrew Sanders Ayers, Hendersonville, TN (US); Navya Kolli, Mt. Juliet, TN (US)

(73) Assignee: Illinois Tool Works Inc., Glenview, IL (US)

(21) Appl. No.: 17/196,789

(22) Filed: Mar. 9, 2021

Related U.S. Application Data
(60) Provisional application No. 62/987,850, filed on Mar. 10, 2020.

(51) Int. Cl. F24C 7/04; H05B 1/02; F24C 15/02; F24C 15/34

(52) U.S. Cl. CPC F24C 7/043; H05B 1/0244; B67D 7/645; F24C 15/34; F24C 15/028

(57) ABSTRACT

A drum heater assembly includes an inner body defining a cylindrical interior space shaped to receive a drum containing a material in the drum, and an elongated heating panels coupled to exterior surfaces of the inner body. The heating panels include heating elements configured to generate heat toward the interior space. The drum heater assembly also includes outer doors coupled with the heating panels such that the heating panels are disposed between the outer doors and the inner body. The inner body is configured to open to remove the drum and insert another drum into the interior space for heating by the heating panels.

### CROSS-REFERENCE TO RELATED APPLICATIONS

This application claims priority to U.S. Provisional Application No. 62/987,850, which was filed on 10 Mar. 2020, and the entire disclosure of which is incorporated by reference herein.

### BACKGROUND

### Technical Field

The subject matter described herein relates to drum heaters, such as heating assemblies that heat barrels or other containers of material.

### Discussion of Art

Some materials stored in containers may need to be heated to retrieve the materials from the containers. For example, metal drums or barrels may need to be heated to melt and pour some materials, such as adhesives, out of the drums or barrels. One known heating assembly for metal drums is a silicone heater formed from a flexible band that is placed around part of the metal drum. The silicone heater is connected to a power source to conduct electric current in the heater and thereby generate heat that is transferred to the metal drum. One problem with this type of heater is that the heater may not be able to be used in some pressurized situations. The band is small compared to the size (e.g., height) of the drum, and may not be able to reinforce the drum in the event there is a rupture caused by the heating of the material inside the drum. While a clamshell may be placed around the drum to reinforce against a rupture of the drum, the clamshell may not able to be placed around the drum while the band is around the drum. Additionally, the silicone heater may need to be removed and re-attached every time a drum is replaced.

Another known heater is a full coverage drum heater. This type of heater can be a flexible body that extends around the drum along the entire height or length of the drum. The full coverage heater can be used to pre-heat or partially melt the adhesive in the drum before the drum is placed in the clamshell. But, this can increase the risk of spillage from the drum during movement of the drum to the clamshell. Additionally, some of the adhesive in the drum that is melted can solidify during the transfer of the drum from the heater to the clamshell. This adhesive may not be able to be re-melted and can end up as wasted material.

### BRIEF DESCRIPTION

In one embodiment, a drum heater assembly includes an inner body defining a cylindrical interior space shaped to receive a drum containing a material in the drum, and an elongated heating panels coupled to exterior surfaces of the inner body. The heating panels include heating elements configured to generate heat toward the interior space. The drum heater assembly also includes outer doors coupled with the heating panels such that the heating panels are disposed between the outer doors and the inner body. The inner body is configured to open to remove the drum and insert another drum into the interior space for heating by the heating panels.

In one embodiment, a drum heater assembly includes a cylindrical clamshell body defining an interior space shaped to receive a drum containing a material in the drum and elongated heating panels coupled to exterior surfaces of the clamshell body. The heating panels include heating elements configured to generate heat toward the interior space. The assembly also includes outer doors coupled with the heating panels such that the heating panels are disposed between the outer doors and the clamshell body. The inner body is configured to open to remove the drum and insert another drum into the interior space for heating by the heating panels.

### BRIEF DESCRIPTION OF THE DRAWINGS

The inventive subject matter may be understood from reading the following description of non-limiting embodiments, with reference to the attached drawings, wherein below:

FIG. 1 is a perspective view of one example of a drum heater assembly;

FIG. 2 is a plan view of the drum heater assembly shown in FIG. 1; and

FIG. 3 illustrates an exploded view of the drum heater assembly shown in FIGS. 1 and 2.

### DETAILED DESCRIPTION

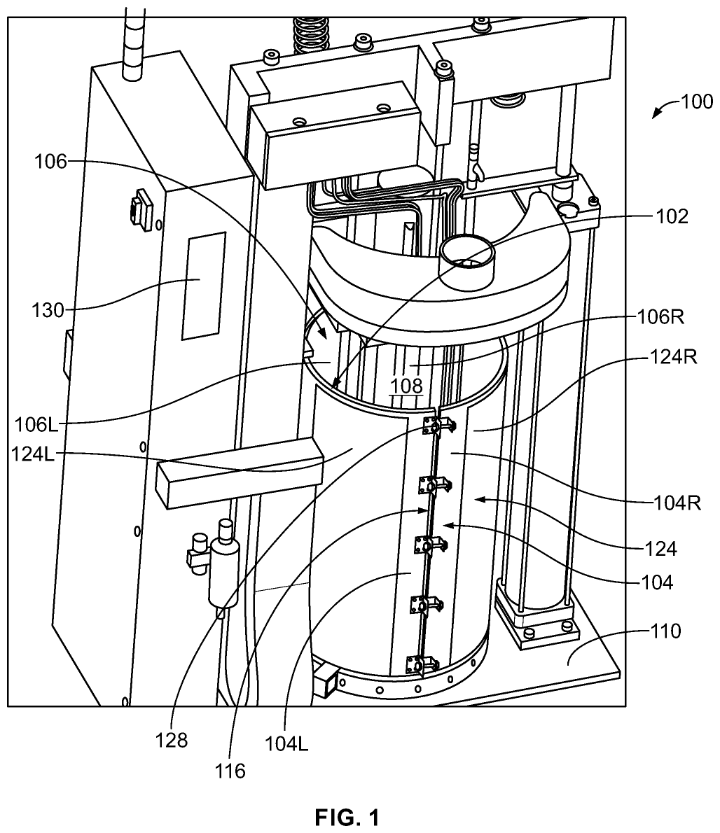

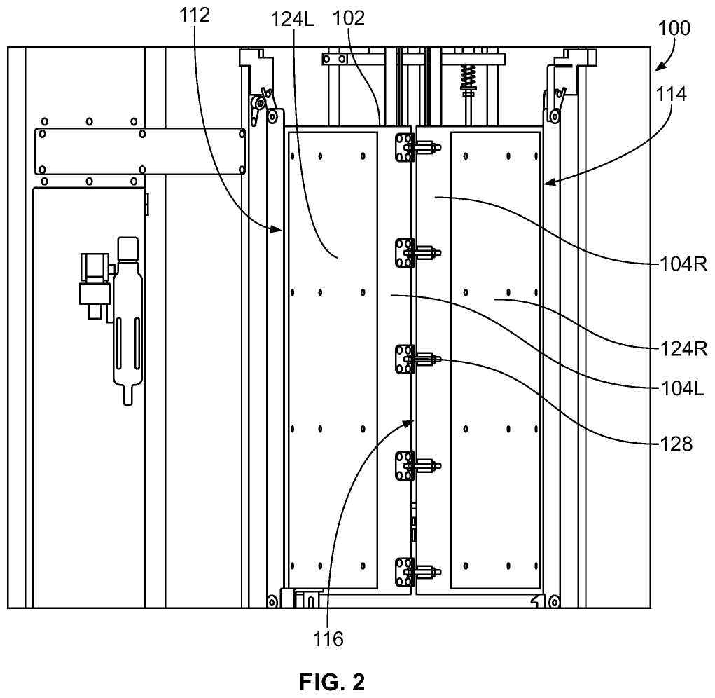

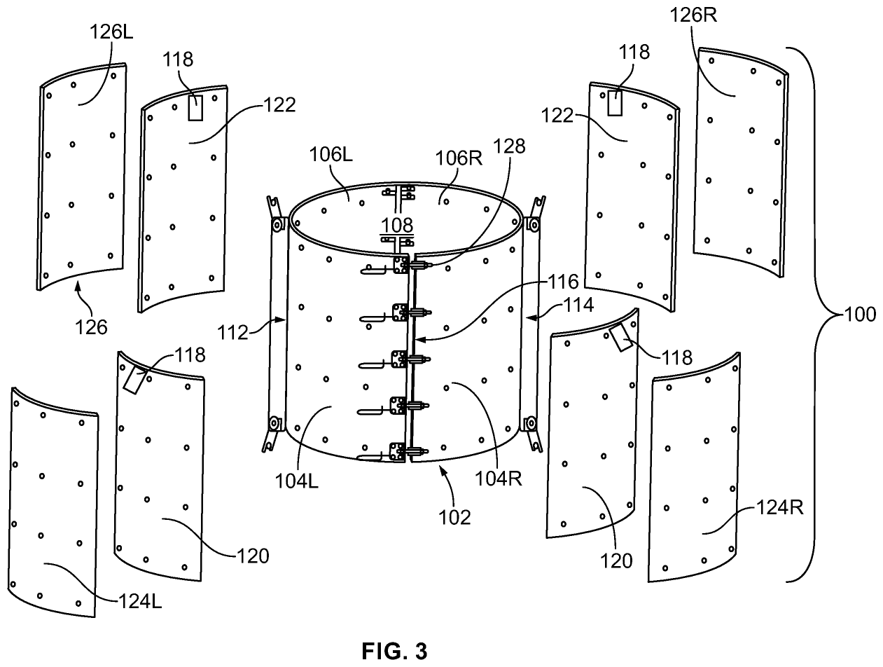

FIG. 1 is a perspective view of one example of a drum heater assembly 100. FIG. 2 is a plan view of the drum heater assembly 100 shown in FIG. 1. FIG. 3 illustrates an exploded view of the drum heater assembly 100 shown in FIGS. 1 and 2.

The heater assembly 100 may be used to heat drums and materials within the drums, such as fifty-five gallon metal drums, sixteen gallon metal drums, ten gallon metal drums, and/or drums made of another material (e.g., one or more polymers). The material inside the drum can be a liquid adhesive or another material having a viscosity that changes when the material is heated. For example, the viscosity of the adhesive may decrease when heated so that the adhesive flows more easily.

The heater assembly 100 includes an inner body 102 formed from several arcuate or curved interior panels 104, 106 (e.g., panels 104L, 104R and panels 106L, 106R). The inner body 102 can have the shape of a cylinder and can be referred to as a clamshell body. These interior panels 104, 106 define a cylindrical chamber or volume 108 of the heater assembly 100 in which a drum or barrel can be positioned. Alternatively, the clamshell body 102 may be formed from two panels. For example, the panels 104L, 106L may be a single panel and the panels 104R, 106R may be a single panel. As another example, the panels 104L, 104R may be a single panel and the panels 106L, 106R may be a single panel. One of these panels may be removed from the other panel to open the clamshell body 102.

The interior panels 104 may be moveable doors while the interior panels 106 are immovable panels in one embodiment. For example, the interior panels 106 may be fixed to a platform 110 of the heater assembly 100 such that the interior panels 106 cannot be moved relative to each other and/or relative to the platform 110. The interior panels 104 may pivot about interfaces 112, 114 with the interior panels 106 (e.g., hinges). For example, the interior panel 104L may be able to rotate about the interface 112 between the interior panel 104L and the interior panel 106L, and the interior panel 104R may be able to rotate about the interface 114 between the interior panel 104R and the interior panel 106R. This rotation can allow the interior panels 104L, 104R to rotate from a closed position (to meet at an interface 116) to an open position (where the interior panels 104L, 104R rotate away from each other and away from the interface 116). The drum can be inserted into the heater assembly 100 once the interior panels 104L, 104R are rotated or pivoted open.

The interior panels 104, 106 can be formed from one or more thermally conductive materials, such as one or more metals (e.g., stainless steel). In one embodiment, the interior panels 104, 106 are formed from twenty-four gauge stainless steel. Alternatively, the interior panels 104, 106 may be formed from another material.

Several heating panels 118 are placed against exterior surfaces of the interior panels 104, 106. These heating panels 118 also may have a curved or arcuate shape. For example, each of the interior panels 104, 106 and the heating panels 118 may have an arcuate shape that extends over part, but not all, of the outer circumference of the interior space or chamber 108. While four interior panels 104, 106 and four heating panels 118 are shown in the illustrated embodiment, alternatively, as few as two interior panels (with at least one moveable panel 104) and as few as one or more heating panels 118 may be used (with the panels extending over larger arcs to encircle the drum in the heater assembly 100).

The heating panels 118 may include outwardly facing thermally insulative surfaces 120. These surfaces 120 can represent one or more layers of insulation. This insulation may be foam insulation, silicon foam insulation, or another type of insulation. Opposite, inwardly facing surfaces 122 of the heating panels 118 may represent heating elements. The inwardly facing surfaces 122 may face (and optionally engage) the outwardly facing surfaces of the interior panels 104, 106. The heating elements can include resistive elements that generate thermal energy due to conduction of electric current into the resistive elements. Alternatively, the heating elements may be conduits through which a heated fluid is passed. In one embodiment, the inwardly facing sides or surfaces 122 are flexible heating elements that are able to flex into different shapes.

Outer doors 124, 126 (e.g., doors 124L, 124R and doors 126L, 126R) are disposed outside of the heating panels 118. These doors 124, 126 can define the outer shape of the heater assembly 100. The doors 124, 126 may be formed from a relatively heavy material to protect others in the event of a rupture of a drum in the interior space 108. For example, the doors 124, 126 may be formed from twenty-four gauge stainless steel.

In operation, the doors 124L, 124R (along with the heating panels 118 and the interior panels 104L, 104R) may be rotated (e.g., manually and/or by one or more motors) away from the interior space 108 to open the interior space 108. A drum or barrel may be inserted into the interior space 108 and the doors 124L, 124R (along with the heating panels 118 and the interior panels 104L, 104R) may be rotated in an opposite direction (e.g., toward the interior space 108) such that the doors 124L, 124R (along with the heating panels 118 and the interior panels 104L, 104R) encircle the drum. Several securing devices 128 (e.g., latches, locks, or the like) on the doors 124L, 124R at or near the interface 116 can secure the doors 124L, 124R (along with the heating panels 118 and the interior panels 104L, 104R) in the closed state around the drum.

As shown, the heating panels 118 extend along a significant portion of the height of the interior space 108. For example, the heating panels 118 may extend over ninety percent of the total height of the interior space 108 in which the drum is placed. This can allow for the heater assembly 100 to heat more of the drum at a time, which can reduce the time needed to heat the drum and/or can more evenly heat the drum.

The clamshell body 102 can support to the drum to help prevent against rupture of the drum during heating. For example, the clamshell body 102 may be shaped such that there is little to no clearance between the body 102 and the drum. The clamshell body 102 can help prevent the sides of the cylindrical drum from rupturing when the drum is heated and gas pressure (e.g., air pressure, noble gas pressure, or the like) is increased in the drum (e.g., via a pump that increases the internal pressure in the drum to extract the heated material in the drum out of the drum). Once heating is complete, the doors 124, 124R (along with the heating panels 118 and the interior panels 104L, 104R) may be opened again to quickly remove the heated drum and insert another drum for heating. The swapping out of the drum may be performed faster than some known heating assemblies. For example, the heating panels 118 do not need to be separately removed from the drum (separately form merely opening the doors 124L, 124R).

The heating panels 118 can receive electric current to generate heat. This can heat the drum and the material within the drum. A human machine interface (HMI) 130 can allow an operator to control the heating of the drum, the pressure generated within the drum, or the like. The heat generated by the heating panels 118 can be transferred from the heating panels 118 to the clamshell body 102, from the clamshell body 102 to the drum, and from the drum to the material inside the drum. The heating panels 118 may be able to heat the drum and material inside the drum to elevated temperatures, such as up to 260 degrees Celsius (or another temperature). The HMI 130 can be used to program the heating panels 118 to turn off or maintain a set temperature (e.g., at a safe handling temperature during swapping out of the drums). The HMI 130 can be used to control the ramp rate at which the temperature generated by the heating panels 118 increases. For example, the rate at which the heating temperature increases can be limited for difficult or volatile materials in drums to allow for better pumping of the materials out of the drums.

The ability to easily open the clamshell body 102 to switch out drums can permit the drums to be swapped out without separately removing the heating panels 118 from the drums. The location of the heating panels 118 around the drums and along most or all of the height of the drums can restrict how much heat escapes from the interior space 108 while also driving the generated heat inward toward the drum.

In one embodiment, a drum heater assembly includes an inner body defining a cylindrical interior space shaped to receive a drum containing a material in the drum, and an elongated heating panels coupled to exterior surfaces of the inner body. The heating panels include heating elements configured to generate heat toward the interior space. The drum heater assembly also includes outer doors coupled with the heating panels such that the heating panels are disposed between the outer doors and the inner body. The inner body is configured to open to remove the drum and insert another drum into the interior space for heating by the heating panels.

Optionally, the heating panels are elongated over substantially all of a height of the drum. For example, each heating panel may be taller than the drum that is received into the assembly. Alternatively, each heating panel may be at least as tall as the drum that is received into the assembly. Alternatively, each heating panel may at least as tall as 80% of the height of the drum that is received into the assembly.

Optionally, the heating panels include thermally insulative layers.

Optionally, the heating elements of the heating panels face inward and toward the interior space and the thermally insulative layers face outward and away from the interior space.

Optionally, the thermally insulative layers include silicon foam insulation.

Optionally, the interior body has a cylindrical shape.

Optionally, the interior body is a clamshell body.

Optionally, the interior body reinforces the drum during pressurized extraction of the material from the drum.

Optionally, the heating panels are configured to heat the material in the drum to temperatures up to two hundred sixty degrees Celsius.

Optionally, the assembly also includes a human-machine interface configured to control heat generated by the heating panels.

Optionally, the human-machine interface is configured to control the heating panels to maintain the drum at a designated temperature during swapping out of the drum.

Optionally, the human-machine interface is configured to control the heating panels to control a ramp rate of the heat generated by the heating panels.

Optionally, the heating panels are curved.

Optionally, the outer doors are curved.

In one embodiment, a drum heater assembly includes a cylindrical clamshell body defining an interior space shaped to receive a drum containing a material in the drum and elongated heating panels coupled to exterior surfaces of the clamshell body. The heating panels include heating elements configured to generate heat toward the interior space. The assembly also includes outer doors coupled with the heating panels such that the heating panels are disposed between the outer doors and the clamshell body. The inner body is configured to open to remove the drum and insert another drum into the interior space for heating by the heating panels.

Optionally, the heating panels are elongated over substantially all of a height of the drum.

Optionally, the heating panels include thermally insulative layers.

Optionally, the heating elements of the heating panels face inward and toward the interior space and the thermally insulative layers face outward and away from the interior space.

Optionally, the thermally insulative layers include silicon foam insulation.

Optionally, the clamshell body has a cylindrical shape.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A drum heater assembly comprising:
an inner body defining a cylindrical interior space shaped to receive a drum containing a material in the drum;
elongated heating panels coupled to exterior surfaces of the inner body, the heating panels including heating elements configured to generate heat toward the interior space; and
outer doors coupled with the heating panels with the heating panels disposed between the outer doors and the inner body,
wherein the inner body is configured to open to remove the drum and insert another drum into the interior space.

2. The drum heater assembly of claim 1, wherein the heating panels are taller than the drum.

3. The drum heater assembly of claim 1, wherein the heating panels include thermally insulative layers.

4. The drum heater assembly of claim 3, wherein the heating elements of the heating panels face inward and toward the interior space and the thermally insulative layers face outward and away from the interior space.

5. The drum heater assembly of claim 3, wherein the thermally insulative layers include silicon foam insulation.

6. The drum heater assembly of claim 1, wherein the interior body has a cylindrical shape.

7. The drum heater assembly of claim 1, wherein the interior body is a clamshell body.

8. The drum heater assembly of claim 1, wherein the interior body reinforces the drum during pressurized extraction of the material from the drum.

9. The drum heater assembly of claim 1, wherein the heating panels are configured to heat the material in the drum to temperatures up to two hundred sixty degrees Celsius.

10. The drum heater assembly of claim 1, further comprising:
a human-machine interface configured to control heat generated by the heating panels.

11. The drum heater assembly of claim 10, wherein the human-machine interface is configured to control the heating panels to maintain the drum at a designated temperature during swapping out of the drum.

12. The drum heater assembly of claim 10, wherein the human-machine interface is configured to control the heating panels to control a ramp rate of the heat generated by the heating panels.

13. The drum heater assembly of claim 1, wherein one or more of the heating panels or the outer doors are curved.

14. A drum heater assembly comprising:
a cylindrical clamshell body defining an interior space shaped to receive a drum containing a material in the drum;
elongated heating panels coupled to exterior surfaces of the clamshell body, the heating panels including heating elements configured to generate heat toward the interior space; and
outer doors coupled with the heating panels with the heating panels disposed between the outer doors and the clamshell body,
wherein the inner body is configured to open to remove the drum and insert another drum into the interior space.

15. The drum heater assembly of claim 14, wherein the heating panels are at least as tall as the drum.

16. The drum heater assembly of claim 14, wherein the clamshell body has a cylindrical shape.

17. The drum heater assembly of claim 14, wherein the heating panels include thermally insulative layers.

18. The drum heater assembly of claim 17, wherein the heating elements of the heating panels face inward and toward the interior space and the thermally insulative layers face outward and away from the interior space.

19. The drum heater assembly of claim 17, wherein the thermally insulative layers include silicon foam insulation.

20. A drum heater assembly comprising:
a cylindrical clamshell body defining an interior space shaped to receive a drum containing a material in the drum;
elongated heating panels coupled to exterior surfaces of the clamshell body, the heating panels including thermally insulative layers and heating elements configured to generate heat toward the interior space, the heating elements facing inward toward the interior space, the thermally insulative layers facing outward away from the interior space, the heating panels elongated over a height of the drum; and
outer doors coupled with the heating panels with the heating panels disposed between the outer doors and the clamshell body,
wherein the inner body is configured to open to remove the drum and insert another drum into the interior space.
